(19) United States
(12) Patent Application Publication
(10) Pub. No.: US 2009/0178503 A1
(43) Pub. Date: Jul. 16, 2009

(54) HUMAN-MACHINE INTERFACE WITH VARIABLE NULL BREAKOUT FORCE

(75) Inventors: James Casey Hanlon, Queen Creek, AZ (US); James I. Kern, Chandler, AZ (US); Justin A. Tanner, Queen Creek, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/972,245

(22) Filed: Jan. 10, 2008

(51) Int. Cl. G05G 9/047

(52) U.S. Cl. 74/471 XY; 180/333

(57) ABSTRACT

A human-machine interface assembly includes a user interface, a first null breakout force mechanism, and a second null breakout force mechanism. The first null breakout force mechanism is coupled to the user interface and is configured to supply the null breakout force to the user interface at a first force magnitude when the user interface is in the null position. The second null break out force mechanism is adapted to receive an engagement signal and is operable, in response to the engagement signal, to engage the user interface and supply the null breakout force to the user interface at a second force magnitude, which is greater than the first force magnitude, when the user interface is in the null position.

### TECHNICAL FIELD

The present invention generally relates to human-machine interfaces and, more particularly, to human-machine interfaces with variable null breakout forces.

### BACKGROUND

Human-machine interfaces that are used to translate human movements to machine movements are used in myriad industries. For example, some aircraft flight control systems include a human-machine interface in the form of one or more hand or foot user interfaces. The user interfaces, or inceptors, are typically configured to be disposed in a null position and the flight control system, in response to input forces supplied to the user interface from the pilot that move the user interface from its null position, controls the movements of various aircraft flight control surfaces. No matter the particular end-use system, the human-machine interface preferably includes some type of haptic feedback mechanism back through the interface to the interface operator. These haptic feedback mechanisms may be implemented using active devices, passive devices, or both.

Haptic feedback mechanisms may, among other functions, supply a force that urges the user interface, when moved from the null position, back toward the null position. Haptic feedback mechanisms also typically supply various tactile cues to the user. For example, many haptic feedback mechanisms implement a null breakout force when the user interface is in the null position. More specifically, when the user interface is in the null position, the haptic feedback mechanism supplies a force to the user interface that, albeit relatively small in magnitude, a user must first overcome in order to move the user interface out of the null position.

In the context of the above-mentioned aircraft user interfaces, it is noted that movement of the user interface (or inceptor) out of the null position during aircraft operation with the aircraft autopilot engaged typically causes the autopilot to automatically disengage. Thus, inadvertent user interface movement with the autopilot engaged can cause a concomitant inadvertent disengagement of the autopilot. Because the null breakout force supplied by the haptic feedback mechanism may, as noted above, be relatively small in magnitude, relatively small inadvertent forces supplied to the user interface can cause undesired autopilot disengagements. While using a haptic feedback mechanism that supplies a relatively greater magnitude null breakout force might alleviate inadvertent autopilot disengagements, it may undesirably increase the forces needed to move the user interface when the autopilot is disengaged.

Hence, there is a need for a user interface haptic feedback mechanism that alleviates inadvertent autopilot disengagements and does not increase the forces needed to move the user interface when the autopilot is disengaged. The present invention addresses at least this need.

### BRIEF SUMMARY

The human-machine interface described herein includes variable null breakout forces. When installed in an aircraft, the configuration precludes inadvertently knocking the aircraft out of autopilot mode.

In one embodiment, and by way of example only, a human-machine interface assembly includes a user interface, a first null breakout force mechanism, and a second null breakout force mechanism. The user interface is configured, upon receipt of an input force that exceeds a null breakout force supplied thereto, to move from a null position to a control position. The first null breakout force mechanism is coupled to the user interface and is configured to supply the null breakout force to the user interface at a first force magnitude when the user interface is in the null position. The second null break out force mechanism is adapted to receive an engagement signal and is operable, in response to the engagement signal, to engage the user interface and supply the null breakout force to the user interface at a second force magnitude when the user interface is in the null position. The second force magnitude is greater than the first force magnitude.

In yet another exemplary embodiment, an aircraft pilot inceptor system for an aircraft having an autopilot includes a user interface, a first null breakout force mechanism, a second null breakout force mechanism, and a flight control computer. The user interface is configured, upon receipt of an input force that exceeds a null breakout force supplied thereto, to move from a null position to a control position. The first null breakout force mechanism is coupled to the user interface and is configured to supply the null breakout force to the user interface at a first force magnitude when the user interface is in the null position. The second null break out force mechanism is adapted to receive an engagement signal and is operable, in response to the engagement signal, to engage the user interface and supply the null breakout force to the user interface at a second force magnitude when the user interface is in the null position. The second force magnitude is greater than the first force magnitude. The flight control computer is adapted to receive an autopilot engage signal whenever the autopilot is engaged and, upon receipt of the autopilot engage signal, to operable supply the engagement signal to the second null break out force mechanism.

In still another exemplary embodiment, an aircraft pilot inceptor system for an aircraft having an autopilot includes a flight control computer, a user interface, passive null breakout force means, and selective null breakout force means. The flight control computer is adapted to receive an autopilot engage signal whenever the autopilot is engaged and, upon receipt of the autopilot engage signal, is operable to supply an engagement signal. The user interface is configured, upon receipt of an input force that exceeds a null breakout force supplied thereto, to move from a null position to a control position. The passive null breakout force means is coupled to the user interface and is for supplying the null breakout force to the user interface at a first force magnitude when the user interface is in the null position. The selective null break out force means is responsive to the engagement signal from the flight control computer for selectively engaging the user interface and for supplying the null breakout force to the user interface at a second force magnitude when engaging the user interface in the null position. The second force magnitude is greater than the first force magnitude.

Furthermore, other desirable features and characteristics of the preferred human-machine interface assembly will become apparent from the subsequent detailed description and the appended claims, taken in conjunction with the accompanying drawings.

### BRIEF DESCRIPTION OF THE DRAWINGS

The present invention will hereinafter be described in conjunction with the following drawing figures, wherein like numerals denote like elements, and wherein:

FIG. 1 is a perspective view of an exemplary fixed-wing aircraft depicting primary and secondary flight control surfaces;

FIG. 2 is a schematic diagram depicting portions of an exemplary flight control surface actuation system that may be used in the exemplary aircraft of FIG. 1; and

FIG. 3 depicts a simplified representation of an exemplary user interface assembly that includes first and second null breakout force mechanisms, and with these mechanisms depicted schematically;

FIG. 4 depicts a plan view of an exemplary physical implementation of the second null breakout force mechanism depicted in FIG. 3; and

FIG. 5 depicts an exemplary configuration of a detent pocket that may be formed in a portion of the mechanism depicted in FIG. 4.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although much of the invention is depicted and described as being implemented for aircraft primary flight control surfaces of fixed wing aircraft, it will be appreciated that it may also be implemented, for example, for cyclic or collective control of the rotating wing in rotating wing aircraft, for aircraft brakes, for aircraft flight simulators, for refueling booms, and/or nose wheel steering. Moreover, although fixed-wing aircraft are depicted and described herein, the invention may also be used in rotary-wing aircraft.

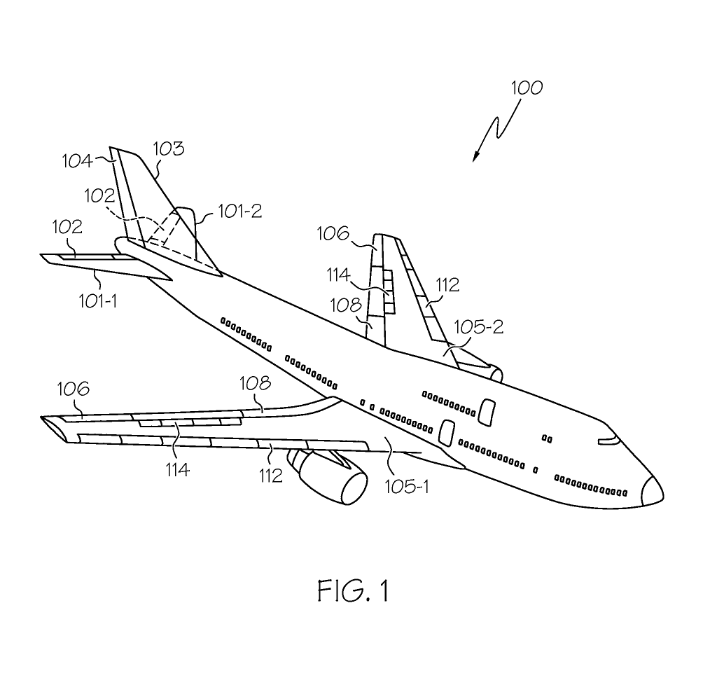

Turning now to FIG. 1, a perspective view of an exemplary aircraft is shown. In the illustrated embodiment, the aircraft 100 includes first and second horizontal stabilizers 101-1 and 101-2, respectively, a vertical stabilizer 103, and first and second wings 105-1 and 105-2, respectively. An elevator 102 is disposed on each horizontal stabilizer 101-1, 101-2, a rudder 104 is disposed on the vertical stabilizer 103, and an aileron 106 is disposed on each wing 105-1, 105-2. In addition, a plurality of flaps 108, slats 112, and spoilers 114 are disposed on each wing 105-1, 105-2. The elevators 102, the rudder 104, and the ailerons 106 are typically referred to as the primary flight control surfaces, and the flaps 108, the slats 112, and the spoilers 114 are typically referred to as the secondary flight control surfaces.

The primary flight control surfaces 102-106 control aircraft movements about the aircraft pitch, yaw, and roll axes. Specifically, the elevators 102 are used to control aircraft movement about the pitch axis, the rudder 104 is used to control aircraft movement about the yaw axis, and the ailerons 106 control aircraft movement about the roll axis. It is noted, however, that aircraft movement about the yaw axis can also be achieved by varying the thrust levels from the engines on opposing sides of the aircraft 100.

The secondary control surfaces 108-114 influence the lift and drag of the aircraft 100. For example, during aircraft take-off and landing operations, when increased lift is desirable, the flaps 108 and slats 112 may be moved from retracted positions to extended positions. In the extended position, the flaps 108 increase both lift and drag, and enable the aircraft 100 to descend at a lower airspeed, and also enable the aircraft 100 get airborne over a shorter distance. The slats 112, in the extended position, increase lift, and are typically used in conjunction with the flaps 108. The spoilers 114, on the other hand, reduce lift and when moved from retracted positions to extended positions, which is typically done during aircraft landing operations, may be used as air brakes to assist in slowing the aircraft 100.

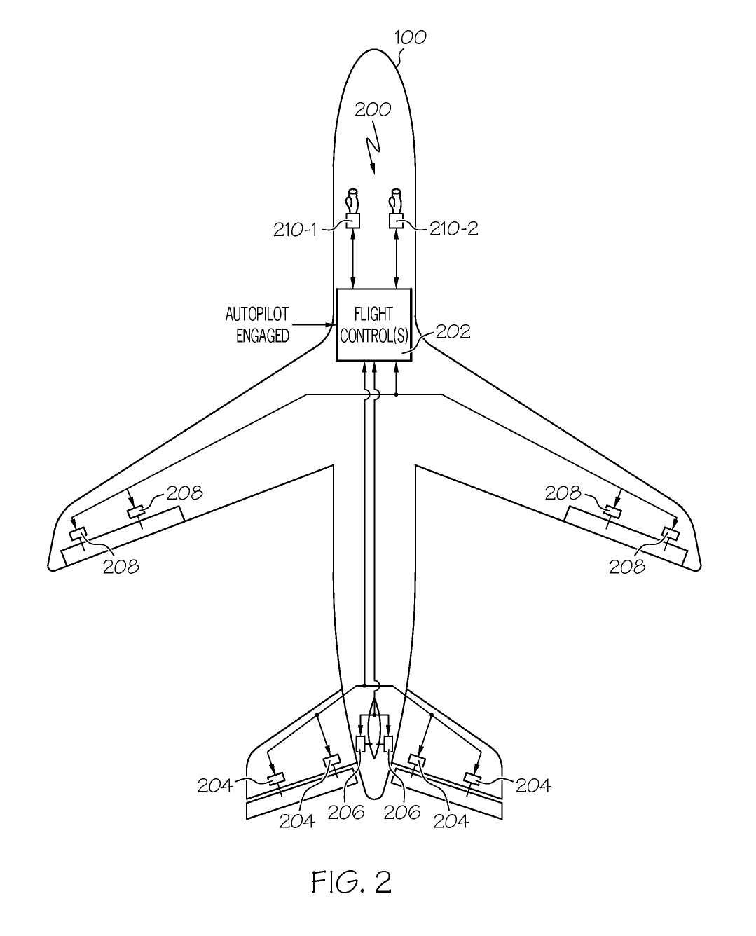

The flight control surfaces 102-114 are moved to commanded positions via a flight control surface actuation system 200, an exemplary embodiment of which is shown in FIG. 2. In the depicted embodiment, the flight control surface actuation system 200 includes flight controls 202, such as one or more flight control computers, a plurality of primary flight control surface actuators, which include elevator actuators 204, rudder actuators 206, and aileron actuators 208. It will be appreciated that the system 200 may be implemented with a plurality of flight control computers 202. However, for ease of description and illustration, only a single, multi-channel control 202 is depicted. It will additionally be appreciated that one or more functions of the flight control computers 202 could be implemented using a plurality of devices.

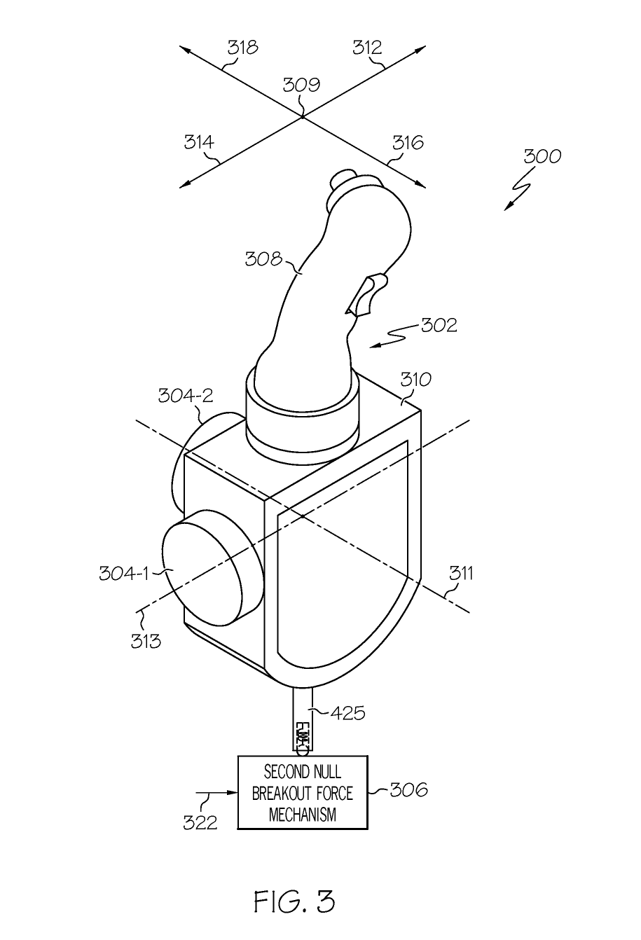

Before proceeding further, it is noted that the flight control surface actuation system 200 additionally includes a plurality of secondary control surface actuators, such as flap actuators, slat actuators, and spoiler actuators. However, the operation of the secondary flight control surfaces 108-114 and the associated actuators is not needed to fully describe and enable the present invention. Thus, for added clarity, ease of description, and ease of illustration, the secondary flight control surfaces and actuators are not depicted in FIG. 2, nor are these devices further described. Moreover, controls for the rudder 104 and non-illustrated aircraft brakes are also not included in FIGS. 2 and 3 for clarity and ease of description. Nonetheless, it will be appreciated that the invention may be applied to rudder and brakes controls in a similar fashion.

Returning now to the description, the flight control surface actuation system 200 may additionally be implemented using various numbers and types of primary flight control surface actuators 204-208. In addition, the number and type of primary flight control surface actuators 204-208 per primary flight control surface 102-106 may be varied. In the depicted embodiment, however, the system 200 is implemented such that two primary flight control surface actuators 204-208 are coupled to each primary flight control surface 102-106. Moreover, each of the primary flight control surface actuators 204-208 are typically a linear-type actuator, such as, for example, a ballscrew actuator or hydraulic cylinder. It will be appreciated that this number and type of primary flight control surface actuators 204-208 are merely exemplary of a particular embodiment, and that other numbers and types of actuators 204-208 could also be used.

No matter the specific number, configuration, and implementation of the primary flight control surface actuators 204-208, the flight control computers 202 are configured to receive aircraft flight control surface position commands from one or more human-machine interfaces. In the depicted embodiment, the system 200 includes two human-machine interfaces (or inceptors), a pilot inceptor 210-1 and a co-pilot user inceptor 210-2. It will be appreciated that in some embodiments the system 200 could be implemented with more or less than this number of user interfaces 210. Moreover, and as was alluded to above, the user interface 210 (or user interfaces) could be implemented as rudder/brake pedals or, if the aircraft is of the rotary-wing type, a cyclic and/or collective.

The flight control computers 202, in response to movement of the user interface 210 or signals supplied from a non-illustrated autopilot, supplies power to the appropriate primary flight control surface actuators 204-208, to move the appropriate primary flight control surfaces 102-106 to positions that will cause the aircraft 100 to implement commanded maneuvers. As FIG. 2 also depicts, the flight control computers 202 also receive an autopilot engage signal whenever the non-illustrated autopilot is engaged. The flight control computers 202, upon receipt of the autopilot engage signal, supplies an engagement signal to the inceptor(s) 210. The purpose for this engagement signal will be described in more detail further below. Before doing so, however, a brief description of an exemplary human-machine interface that may be used to implement the inceptor(s) 210 will first be provided.

A simplified representation of an embodiment of a portion of an exemplary human-machine interface assembly 300 that may be used to implement the user interface(s) 210 described above is depicted in FIG. 3. The depicted human-machine interface assembly 300 includes a user interface 302, one or more first null breakout force mechanisms 304 (two depicted), and a second null breakout force mechanism 306. The user interface 302 is configured to receive an input force from a user, such as a pilot (or co-pilot), and includes a grip 308 and a gimbal assembly 3 10. The grip 308 is coupled to the gimbal assembly 310 and may be implemented according to any one of numerous configurations. Moreover, the grip 308 is preferably dimensioned to be grasped by a hand of a pilot (or co-pilot) or other user.

The gimbal assembly 310 is preferably mounted within a suitable, non-illustrated housing assembly, and is configured to allow the user interface 302 to be moved from a null position 309, which is the position depicted in FIG. 3, to a plurality of control positions in a plurality of directions. More specifically, the gimbal assembly 310, in response to an input force supplied to the grip 308, allows the user interface 302 to be moved from the null position 309 to a plurality of control positions, about two perpendicular rotational axes—a first rotational axis 311 and a second rotational axis 313. It will be appreciated that in the context of a pilot (or co-pilot) inceptor, the first and second rotational axes 311, 313 may be referred to as the roll axis and the pitch axis, respectively.

The gimbal assembly 310 is configured to allow the user interface 302 to be movable about the first rotational axis 311 in a port direction 312 and a starboard direction 314, and about the second axis 313 in a forward direction 316 and an aft direction 318. It will additionally be appreciated that the gimbal assembly 310 is configured to allow the user interface 302 to be simultaneously rotated about the first and second rotational axes 311, 313 to move the user interface 302 in a combined forward-port direction, a combined forward-starboard direction, a combined aft-port direction, or a combined aft-starboard direction, and back to or through the null position 309. It will be appreciated that the gimbal assembly 310 may be configured using any one of numerous gimbal assembly implementations now known or developed in the future. Furthermore, a detailed description of the gimbal assembly 104 is not needed to fully enable or describe the invention, and will thus not be provided.

Before proceeding further, it is noted that the human-machine interface assembly 300 may be implemented as either an active system or a passive system. If implemented as an active system, the human-machine interface assembly 300 may further include one or more non-illustrated motors to actively supply force feedback to the user interface 302. If implemented as a passive system, it will be appreciated that the human-machine interface assembly 300 would not include any motors. In either instance, however, the human-machine interface assembly 300 would preferably include the first and second null breakout force mechanisms 304, 306. In the case of the active system, the motors would be the primary means of supplying at least the null breakout force to the user interface 302, with the passive force feedback mechanisms 106 being the back-up feedback force source. It will nonetheless be appreciated that in the remainder of the description, the assembly 100 is described as if it were implemented as a fully passive system, without any motors.

The first and second null breakout force mechanisms 304, 306, which in the depicted embodiment are depicted schematically, are each coupled to the user interface 302. The first null breakout force mechanism 304, which is preferably a passive device, such as a spring, is configured to at least supply a null breakout force to the user interface 302 at a first force magnitude when the user interface 302 is in the null position 309. As is generally known, the null breakout force is an amount of force a user (such as a pilot or co-pilot) needs to supply to the user interface 302 to move it out of the null position 309. The first null breakout force mechanism 304 may also be, and preferably is, configured to supply force feedback to the user interface 302 in opposition to user interface displacements having a vector component in either the forward or backward direction 316, 318. As FIG. 3 also depicts, the human-machine interface assembly 300 may include a pair of first null breakout force mechanisms 304 (e.g., 304-1, 304-2), one each associated with each of the rotational axes 311, 313.

The second null breakout force mechanism 306 is also coupled to the user interface 302, and is also configured to supply a null breakout force to the user interface 302 when the user interface 302 is in the null position 309. However, unlike the first null breakout force mechanism(s) 304, the second null breakout force mechanism 306 is preferably configured to only selectively supply the null breakout force and, when it does, it supplies the null breakout force at a second force magnitude that is greater than the first force magnitude. More specifically, the second null breakout force mechanism 306 is configured to selectively engage the user interface 302. To do so, the second null breakout force mechanism 306 is coupled to receive an engagement signal 322 and is operable, in response to the engagement signal, to engage the user interface 302 and supply the null breakout force to the user interface 302 at the second force magnitude.

It is noted that the engagement signal 322 that is supplied to the second null breakout force mechanism 306 may originate from any one of numerous sources. However, in the context of the flight control system 200 depicted in FIG. 2, the engagement signal 322 originates from the flight control computers 202. In particular, as was previously noted, the flight control computers 202, supplies the engagement signal 322 in response to receiving the autopilot engaged signal. It will be appreciated that the flight control computers 202 may additionally be configured to supply a disengagement signal to the second null breakout force mechanism 306 when the autopilot is disengaged. Whether it does may depend, for example, on the configuration and implementation of the second null breakout force mechanism 306. Preferably, however, the flight control computers 202 is configured such that the engagement signal 322 energizes the second null breakout force mechanism 306, and removal of the engagement signal 322 deenergizes the second null breakout force mechanism 306. Moreover, the second null breakout force mechanism 306, an embodiment of which will now be described, is configured to supply the null breakout force to the user interface 302 at the second force magnitude when it is energized, and to not supply the null breakout force to the user interface 302 when it is deenergized.

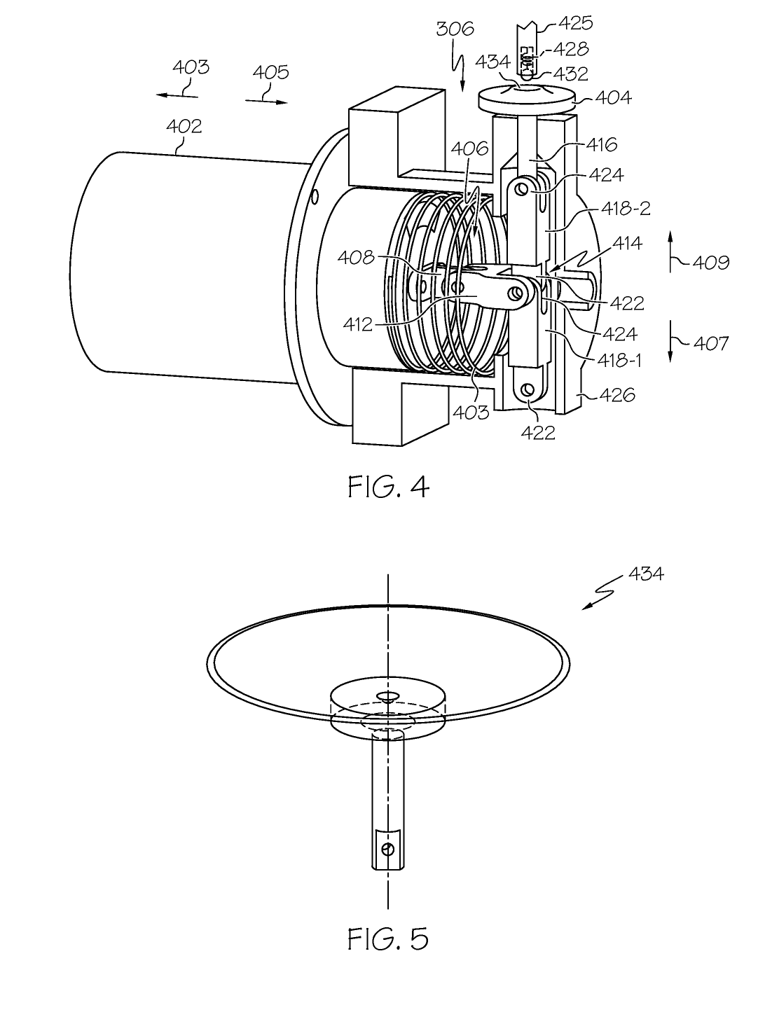

A particular embodiment of the second null breakout force mechanism 306 is depicted in FIG. 4, and includes an actuator 402 and a plate 404. The actuator 402 is coupled to receive the engagement signal 322 from the flight control computers 202 and is operable, in response to the engagement signal, to move between a retracted position and a deployed position and supply an engagement drive force or a disengagement drive force to the plate 404. It will be appreciated that the actuator 402 may be implemented using any one of numerous known actuators, and may be variously configured. For example, the actuator 402 may be implemented using anyone of numerous ball screw actuators, any one of numerous acme screw actuators, or any one of numerous solenoids, just to name a few. In the depicted embodiment, the actuator 402 is implemented using a voice coil actuator that is biased, via a spring 403, toward the retracted position. The actuator 402, upon being energized via the engagement signal 322, moves to the deployed position and supplies the engagement drive force to the plate 404. The actuator 402, upon being deenergized, moves to the retracted position, via the bias force supplied from the spring 403, and supplies the disengagement drive force to the plate 404.

It is seen that, at least in the depicted embodiment, the engagement and disengagement drive forces are supplied to the plate 404 via a linkage mechanism 406. The linkage mechanism 406 is coupled between the actuator 402 and the plate 404, and may be variously configured. In the depicted embodiment, however, the linkage mechanism includes an output link 408, an intermediate link 412, and an actuation link 414. The output link 408 is coupled to the actuator 402 and to the intermediate link 412. The intermediate link 412 is in turn coupled to the actuation link 414, which is coupled to the plate 404 via a plate extension shaft 416. The actuation link 414 includes a pair of identical links—namely, a first link 418-1 and a second link 418-2. The first and second links 418-1, 418-2 each include a first end 422 and a second end 424. The first end 422 of the first link 418-1 is pivotally coupled to a guide structure 426, and the second end 424 of the first link 418-1 is pivotally coupled to the first end 422 of the second link 418-2, and is also pivotally coupled to the intermediate link 412. The second end 424 of the second link 418-2 is in turn pivotally coupled to the plate extension shaft 416.

With the above-described linkage mechanism configuration, when the actuator 402 translates between the retracted and deployed positions, in first and second directions as indicated by arrows 403 and 405, respectively, the output link 408 and intermediate link 412 concomitantly translate in the first and second directions 403 and 405, respectively. Because the intermediate link 412 is pivotally coupled, in the manner described above, to the actuation link 414, and the actuation link 414 is pivotally coupled, also in the manner described above, to the plate 404, the plate 404 translates in orthogonal third and fourth directions as indicated by arrows 407 and 409, respectively. Translation of the plate 404 in the third and fourth directions 407, 409 causes the plate 404 to selectively disengage and engage the user interface 302, respectively, to thereby remove and supply, respectively, the null breakout force to the user interface 302 at the second force magnitude.

It is noted that the actuator 402 and the linkage mechanism 406 are preferably disposed and configured such that the actuation link 414 is not allowed to move to a centered or actuationed position. In this manner, whenever the actuator 402 is deenergized, either purposely or due to a loss of electrical power, the second null breakout force mechanism 306 will disengage the user interface 302.

To assist in implementing the above-described functionality of the second null breakout force mechanism 306, a rod 425 (depicted in FIGS. 3 and 4) is coupled to and extends from the user interface 302. The rod 425 has a ball socket 428 formed therein (shown in phantom in FIG. 4). A spring-loaded ball 432 is disposed in, and extends partially from, the ball socket 428. Moreover, a detent pocket 434 is formed in the plate 404, and is dimensioned to receive the spring-loaded ball 432 when the plate 404 is moved to the engaged position. It may thus be appreciated that when the plate 404 is in the engaged position, and thus the spring-loaded ball 432 is disposed in the detent pocket 434, movement of the user interface 302 out of the null position 309 will not occur unless a force is applied to the user interface 302 that is sufficient (e.g., at least equal to the null breakout force of the second force magnitude) to force the spring-loaded ball 432 out of the detent pocket 434. A particular configuration of the detent pocket 434 is depicted in FIG. 5. It will nonetheless be appreciated that this configuration is merely exemplary, and that the detent pocket 434 may be variously configured and dimensioned.

The human-machine interface assembly 300 described herein provides for variable null breakout forces for pilot inceptors, and various other user interfaces. In the context of an aircraft flight control system 200, when the autopilot is not engaged, the plate 404 will be in its disengaged position and the null breakout force is supplied solely by the first null breakout force mechanism 304. However, when the autopilot is engaged, the engagement signal 322 is supplied to the second null breakout force mechanism 306, and more specifically to the actuator 402. As a result, the plate 404 is moved into engagement with the user interface 302, and more specifically into engagement with the spring-loaded ball 432, supplying the null breakout force to the user interface 302 at the second force magnitude.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A human-machine interface assembly, comprising:
a user interface configured, upon receipt of an input force that exceeds a null breakout force supplied thereto, to move from a null position to a control position; and
a first null breakout force mechanism coupled to the user interface and configured to supply the null breakout force to the user interface at a first force magnitude when the user interface is in the null position; and
a second null break out force mechanism adapted to receive an engagement signal and operable, in response to the engagement signal, to engage the user interface and supply the null breakout force to the user interface at a second force magnitude when the user interface is in the null position, the second force magnitude being greater than the first force magnitude.

2. The assembly of claim 1, wherein the second null breakout force mechanism comprises:
an actuator adapted to receive the engagement signal and operable, in response thereto, to supply an engagement drive force; and
a plate coupled to receive the engagement drive force from the actuator and operable, in response thereto, to engage the user interface and supply the null breakout force to the user interface at the second force magnitude.

3. The assembly of claim 2, wherein:
the user interface comprises a spring-loaded ball; and
the plate comprises a detent pocket formed therein for receiving the spring-loaded ball.

4. The assembly of claim 3, wherein the user interface further comprises:
a gimbal assembly;
a grip coupled to the gimbal assembly and configured to be grasped by a hand; and
a rod coupled to and extending from the gimbal assembly, the rod having a ball socket formed therein and within which the spring-loaded ball is disposed.

5. The assembly of claim 2, wherein:
the actuator is further adapted to receive a disengagement signal and is operable, in response thereto, to supply a disengagement drive force; and
the plate is further coupled to receive the disengagement drive force from the actuator and is further operable, in response thereto, to disengage the user interface.

6. The assembly of claim 2, wherein:
the actuator is further operable, upon being electrically deenergized, to supply a disengagement drive force; and
the plate is further coupled to receive the disengagement drive force from the actuator and is further operable, in response thereto, to disengage the user interface.

7. The assembly of claim 6, wherein the actuator comprises a spring configured to supply the disengagement drive force.

8. The assembly of claim 2, wherein the actuator is selected from the group consisting of a voice coil actuator, a ball screw actuator, an acme screw actuator, and a solenoid.

9. The assembly of claim 2, further comprising:
a linkage mechanism coupled between the actuator and the plate, the linkage mechanism configured to transmit the engagement force from the actuator to the plate.

10. The assembly of claim 2, wherein:
the linkage mechanism comprises an actuation link; and
the actuator is configured to at least inhibit movement of the actuation link to a center position or an over center position.

11. The assembly of claim 1, wherein the first null breakout force mechanism comprises a passive force feedback mechanism.

12. The assembly of claim 2, wherein the passive force feedback mechanism comprises a spring.

13. An aircraft pilot inceptor system for an aircraft having an autopilot, comprising:
a user interface configured, upon receipt of an input force that exceeds a null breakout force supplied thereto, to move from a null position to a control position; and
a first null breakout force mechanism coupled to the user interface and configured to supply the null breakout force to the user interface at a first force magnitude when the user interface is in the null position;
a second null break out force mechanism adapted to receive an engagement signal and operable, in response to the engagement signal, to engage the user interface and supply the null breakout force to the user interface at a second force magnitude when the user interface is in the null position, the second force magnitude being greater than the first force magnitude; and
a flight control computer adapted to receive an autopilot engage signal whenever the autopilot is engaged and, upon receipt of the autopilot engage signal, is operable to supply the engagement signal to the second null break out force mechanism.

14. The system of claim 13, wherein the second null breakout force mechanism comprises:
an actuator adapted to receive the engagement signal and operable, in response thereto, to supply an engagement drive force; and
a plate coupled to receive the engagement drive force from the actuator and operable, in response thereto, to engage the user interface and supply the null breakout force to the user interface at the second force magnitude.

15. The system of claim 13, wherein:
the user interface comprises a spring-loaded ball; and
the plate comprises a detent pocket formed therein for receiving the spring-loaded ball.

16. The system of claim 15, wherein the user interface further comprises:
a gimbal assembly;
a grip coupled to the gimbal assembly and configured to be grasped by a hand; and
a rod coupled to and extending from the gimbal assembly, the rod having a ball socket formed therein and within which the spring-loaded ball is disposed.

17. The system of claim 14, wherein:
the actuator is further operable, upon being electrically deenergized, to supply a disengagement drive force;
the actuator comprises a spring configured to supply the disengagement drive force; and
the plate is further coupled to receive the disengagement drive force from the actuator and is further operable, in response thereto, to disengage the user interface.

18. The system of claim 14, further comprising:
an actuation link coupled between the actuator and the plate, the linkage mechanism configured to transmit the engagement force from the actuator to the plate,
wherein the actuator is configured to at least inhibit movement of the actuation link to a center position or an over center position.

19. The system of claim 13, wherein the first null breakout force mechanism comprises a passive force feedback mechanism.

20. An aircraft pilot inceptor system for an aircraft having an autopilot, comprising:
a flight control computer adapted to receive an autopilot engage signal whenever the autopilot is engaged and, upon receipt of the autopilot engage signal, is operable to supply an engagement signal;
a user interface configured, upon receipt of an input force that exceeds a null breakout force supplied thereto, to move from a null position to a control position; and
passive null breakout force means, coupled to the user interface, for supplying the null breakout force to the user interface at a first force magnitude when the user interface is in the null position;
selective null break out force means responsive to the engagement signal from the flight control computer for (i) selectively engaging the user interface and (ii) supplying the null breakout force to the user interface at a second force magnitude when engaging the user interface in the null position, the second force magnitude being greater than the first force magnitude.
